(19) United States
(12) Patent Application Publication
(10) Pub. No.: US 2009/0137709 A1
(43) Pub. Date: May 28, 2009

(54) POLYOL-CONTAINING, FLAME-RESISTANT POLYCARBONATES, PROCESSES FOR PREPARING THE SAME AND PRODUCTS CONTAINING THE SAME

(75) Inventors: Berit Krauter, Neuss (DE); Wolfgang Ebert, Krefeld (DE); Michael Prein, Krefeld (DE); Michael Wagner, Moers (DE)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/262,346

(22) Filed: Oct. 31, 2008

(30) Foreign Application Priority Data
Nov. 2, 2007 (DE) 102007052783.9

(51) Int. Cl. C08K 5/42; C08K 5/435

(52) U.S. Cl. 524/157; 524/168

(57) ABSTRACT

Flame-resistant compositions comprising: a polycarbonate; 0.01 to <0.3 wt. % of a polyol; and 0.01 to 0.8 wt. % of a salt of a metal selected from the group consisting of alkali metals, alkaline earth metals and mixtures thereof, and a compound selected from the group consisting of sulfonic acids, sulfonamides, sulfonimides and mixtures thereof; processes for preparing the same and products prepared therewith.

### BACKGROUND OF THE INVENTION

Plastics molding compositions which have been provided with flame-resistant properties are used for a large number of applications. Typical fields of use of such plastics are, inter alia, electrical engineering and electronics, where they are used, for example, to produce carriers for live parts or in the form of television and monitor casings. However, plastics which have been provided with flame-resistant properties have also become firmly established in the field of interior paneling for railway vehicles or aircraft. In this case, the plastics used must also exhibit a high level of further positive properties in addition to good flameproof properties.

In the past there has been no lack of attempts to further increase the flame resistance of plastics.

For example, JP-A 02-202544, the entire contents of which are hereby incorporated herein by reference, describes compositions comprising aromatic sulfonic acid metal salts in amounts of from 0.01 to 2 parts by weight, preferably from 0.05 to 1.5 parts by weight, and from 0.01 to 3.0 parts by weight, preferably from 0.01 to 2.0 parts by weight (in each case based on 100 parts by weight of polycarbonate), of alkylene glycol oligomers, as well as injection-molded articles produced therefrom having improved flame resistance as well as good transparency and a reduced tendency to color changes. An object of this application was to provide flameproof transparent polycarbonate (PC) compositions. It is described that a combination of polyalkylene glycol having a molecular weight of from 200 to 1000 with a metal salt of an aromatic sulfonic acid yields a flameproof transparent PC composition.

JP-A 02-202544, the entire contents of which are hereby incorporated herein by reference, expressly states that the transparency of compositions comprising polyalkylene glycol having a molecular weight>1000 decreases. The application describes polycarbonate compositions that comprise 0.1 wt. % potassium diphenylsulfonate and 0.3 wt. % polyethylene glycol having a molecular weight of 600 or 3400 (examples).

US 2006/0116467 A1, the entire contents of which are hereby incorporated herein by reference, describes a process for the production of flameproof thermoplastic molding compositions using aqueous PTFE dispersions. EP-A 0 374 816, the entire contents of which are hereby incorporated herein by reference, relates to a process for the dispersion of one or more flameproofing additives in carbonate polymers in order to improve the impact-resistant properties of the flameproof polymer. US 2007/0129465 A1, the entire contents of which are hereby incorporated herein by reference, describes compositions comprising organic polymers, in which surface-modified particles are dispersed in an amount suitable for reducing the flammability of the polymer. U.S. Pat. No. 6,469,072 B1, the entire contents of which are hereby incorporated herein by reference, discloses a method of dispersing solid additives in polymers with the aid of mixers. U.S. Pat. No. 6,455,620 B1, the entire contents of which are hereby incorporated herein by reference, discloses compositions comprising an oxidation catalyst and at least one polyether from the group of the polyalkylene glycols. U.S. Pat. No. 3,215,663, the entire contents of which are hereby incorporated herein by reference, describes a process for the dispersion of pigments in linear synthetic polymers having a high molecular weight. U.S. Pat. No. 5,118,721, the entire contents of which are hereby incorporated herein by reference, describes a process for the production of filler dispersions using polyether polyols.

### BRIEF SUMMARY OF THE INVENTION

The present invention relates to compositions comprising polycarbonate as well as a combination of polyol and alkali or alkaline earth salt of an aliphatic or aromatic sulfonic acid, sulfonamide or sulfonimide in specific amounts.

Despite the many various prior attempts, there continues to be significant room for improved flame-resistant compositions, in particular for use in thin-walled products. This is particularly true of transparent compositions or compositions for transparent products. Various embodiments of the present invention provide transparent compositions which exhibit markedly improved flame resistance at wall thicknesses of less than or equal to 3 mm.

Within the scope of the present invention it has been found that providing compositions comprising polycarbonate with a combination of alkali or alkaline earth salt of an aliphatic or aromatic sulfonic acid, sulfonamide or sulfonimide and small amounts of polyol yields an excellent property profile in respect of transparency and flameproofing, in particular in the case of polyols having a molecular weight>1000, while the concentration of flameproofing additive and polyol is lower overall.

The present invention therefore relates to compositions comprising polycarbonate and from 0.01 wt. % to <0.3 wt. % polyol and from 0.01 wt. % to 0.8 wt. % of an alkali or alkaline earth salt of an aliphatic or aromatic sulfonic acid, sulfonamide or sulfonimide.

Such compositions can advantageously be used in various applications. These include, for example, applications in the electrical engineering/electronics field, such as, for example, light housings, electrical safety switches, multiway connectors, or television or monitor casings. The compositions according to the invention can additionally be used in the form of sheets for architectural or industrial glazing and as paneling for railway vehicle and aircraft interiors, of each of which high demands are made in respect of flame resistance.

One embodiment of the present invention includes a composition comprising: a polycarbonate; 0.01 to <0.3 wt. % of a polyol; and 0.01 to 0.8 wt. % of a salt of a metal selected from the group consisting of alkali metals, alkaline earth metals and mixtures thereof, and a compound selected from the group consisting of sulfonic acids, sulfonamides, sulfonimides and mixtures thereof.

The present invention relates also to a process for the preparation of a composition according to the invention, characterized in that polycarbonate, at least one polyol and at least one alkali or alkaline earth salt of an aliphatic or aromatic sulfonic acid, sulfonamide or sulfonimide are combined and mixed, optionally in a solvent, optionally with homogenization, and the solvent is removed. The polymer compound is subsequently granulated, for example, and processed further directly to form moldings.

### DETAILED DESCRIPTION OF THE INVENTION

As used herein, the singular terms “a” and “the” are synonymous and used interchangeably with “one or more” and “at least one,” unless the language and/or context clearly indicates otherwise, Accordingly, for example, reference to “a polyol” herein or in the appended claims can refer to a single polyol or more than one polyol, Additionally, all numerical values, unless otherwise specifically noted, are understood to be modified by the word “about.”

Polycarbonates suitable for use in compositions according to the invention include homopolycarbonates, copolycarbonates and thermoplastic, preferably aromatic, polyester carbonates, which are subsumed under the term “polycarbonate” in the present application.

The homopolycarbonates, copolycarbonates and polyester carbonates according to the invention generally have mean molecular weights (weight-average) of from 2000 to 200,000, preferably from 3000 to 150,000, especially from 5000 to 100,000, most particularly preferably from 8000 to 80,000, in particular from 12,000 to 70,000 (determined by GPC with polycarbonate calibration), most particularly preferably mean molecular weights M̅_{w} of from 16,000 to 40,000 g/mol.

For the preparation of polycarbonates for the compositions according to the invention, reference may be made, for example, to “Schnell”, Chemistry and Physics of Polycarbonates, Polymer Reviews, Vol. 9, Interscience Publishers, New York, London, Sydney 1964, to D. C. PREVORSEK, B. T. DEBONA and Y. KESTEN, Corporate Research Center, Allied Chemical Corporation, Moristown, N.J. 07960, “Synthesis of Poly(ester)carbonate Copolymers” in Journal of Polymer Science, Polymer Chemistry Edition, Vol. 19, 75-90 (1980), to D. Freitag, U. Grigo, P. R. Miller, N. Nouvertne, BAYER AG, “Polycarbonates” in Encyclopedia of Polymer Science and Engineering, Vol. 11, Second Edition, 1988, pages 648-718, and finally to Dres. U. Grigo, K. Kircher and P. R. Müller “Polycarbonate” in Becker/Braun, Kunststoff-Handbuch, Volume 3/1, Polycarbonate, Polyacetale, Polyester, Celluloseester, Carl Hanser Verlag Munich, Vienna 1992, pages 117-299. The preparation is preferably carried out by the interfacial process or the melt transesterification process and is described first using the example of the interfacial process.

Compounds which are preferably to be used as starting materials are bisphenols of the general formula (1) HO-Z-OH, wherein Z is a divalent organic radical having from 6 to 30 carbon atoms, which contains one or more aromatic groups.

Examples of such compounds are bisphenols belonging to the group of the dihydroxydiphenyls, bis(hydroxyphenyl)alkanes, indanebisphenols, bis(hydroxyphenyl)ethers, bis(hydroxyphenyl)sulfones, bis(hydroxyphenyl) ketones and α,α′-bis(hydroxyphenyl)-diisopropylbenzenes.

Particularly preferred bisphenols belonging to the above-mentioned groups of compounds are bisphenol A, tetraalkylbisphenol A, 4,4-(meta-phenylene-diisopropyl)diphenol (bisphenol M), 4,4-(para-phenylenediisopropyl)diphenol, N-phenyl-isatinbisphenol, 1,1-bis-(4-hydroxyphenyl)-3,3,5-trimethylcyclohexane (BP-TMC), bisphenols of the 2-hydrocarbyl-3,3-bis(4-hydroxyaryl)phthalimidine type, in particular 2-phenyl-3,3-bis(4-hydroxyphenyl)phthalimidine, and also optionally mixtures thereof. Particular preference is given to homopolycarbonates based on bisphenol A and copolycarbonates based on the monomers bisphenol A and 1,1-bis-(4-hydroxyphenyl)-3,3,5-trimethylcyclohexane. The bisphenol compounds to be used according to the invention are reacted with carbonic acid compounds, in particular phosgene or, in the case of the melt transesterification process, diphenyl carbonate or dimethyl carbonate.

Polyester carbonates are obtained by reaction of the bisphenols already mentioned, at least one aromatic dicarboxylic acid and optionally carbonic acid equivalents. Suitable aromatic dicarboxylic acids are, for example, phthalic acid, terephthalic acid, isophthalic acid, 3,3′- or 4,4′-diphenyldicarboxylic acid and benzophenonedicarboxylic acids. It is possible to replace some, up to 80 mol %, preferably from 20 to 50 mol %, of the carbonate groups in the polycarbonates by aromatic dicarboxylic acid ester groups.

Inert organic solvents used in the interfacial process are, for example, dichloromethane, the various dichloroethanes and chloropropane compounds, tetrachloromethane, trichloromethane, chlorobenzene and chlorotoluene. Chlorobenzene or dichloromethane, or mixtures of dichloromethane and chlorobenzene, are preferably used.

The interfacial process can be accelerated by catalysts such as tertiary amines, in particular N-alkylpiperidines or onium salts. Tributylamine, triethylamine and N-ethylpiperidine are preferably used. In the case of the melt transesterification process, the catalysts mentioned in DE-A 42 38 123 are used.

The polycarbonates can be branched in a deliberate and controlled manner by the use of small amounts of branching agents. Some suitable branching agents are: isatinbiscresol, phloroglucinol, 4,6-dimethyl-2,4,6-tri-(4-hydroxyphenyl)-hept-2-ene; 4,6-dimethyl-2,4,6-tri-(4-hydroxyphenyl)-heptane; 1,3,5-tri-(4-hydroxyphenyl)-benzene; 1,1,1-tri-(4-hydroxyphenyl)-ethane; tri-(4-hydroxyphenyl)-phenylmethane; 2,2-bis-[4,4-bis-(4-hydroxyphenyl)-cyclohexyl]-propane; 2,4-bis-(4-hydroxyphenyl)-isopropyl)-phenol; 2,6-bis-(2-hydroxy-5′-methyl-benzyl)-4-methylphenol; 2-(4-hydroxyphenyl)-2-(2,4-dihydroxyphenyl)-propane; hexa-(4-(4-hydroxyphenyl-isopropyl)-phenyl)-orthoterephthalic acid ester; tetra-(4-hydroxyphenyl)-methane; tetra-(4-(4-hydroxyphenyl-isopropyl)-phenoxy)-methane; α,α′,α″-tris-(4-hydroxyphenyl)-1,3,5-triisopropylbenzene; 2,4-dihydroxybenzoic acid; trimesic acid; cyanuric chloride; 3,3-bis-(3-methyl-4-hydroxyphenyl)-2-oxo-2,3-dihydroindole; 1,4-bis-(4′,4″-dihydroxytriphenyl)-methyl)-benzene and in particular: 1,1,1-tri-(4-hydroxyphenyl)-ethane and his-(3-methyl-4-hydroxyphenyl)-2-oxo-2,3-dihydroindole.

The 0.05 to 2 mol %, based on diphenols used, of branching agents or mixtures of branching agents that are optionally to be employed concomitantly can be used together with the diphenols or can be added at a later stage of the synthesis.

Chain terminators can be used. There are preferably used as chain terminators phenols such as phenol, alkylphenols such as cresol and 4-tert-butylphenol, chlorophenol, bromophenol, cumylphenol or mixtures thereof in amounts of from 1 to 20 mol %, preferably from 2 to 10 mol %, per mole of bisphenol. Phenol 4-tert-butylphenol and cumylphenol are preferred. Chain terminators and branching agents can be added to the syntheses separately or together with the bisphenol.

The preferred polycarbonate according to the invention is bisphenol A homopolycarbonate.

Alternatively, it is also possible to prepare the polycarbonates according to the invention by the melt transesterification process. The melt transesterification process is described, for example, in Encyclopedia of Polymer Science, Vol. 10 (1969), Chemistry and Physics of Polycarbonates, Polymer Reviews, H. Schnell, Vol. 9, John Wiley and Sons, Inc. (1964) as well as in DE-C 10 31 512.

In the melt transesterification process, the aromatic dihydroxy compounds already described in the interfacial process are transesterified in the melt with carbonic acid diesters with the aid of suitable catalysts and optionally further additives.

Carbonic acid diesters within the scope of the invention are those of formulae (1) and (2)

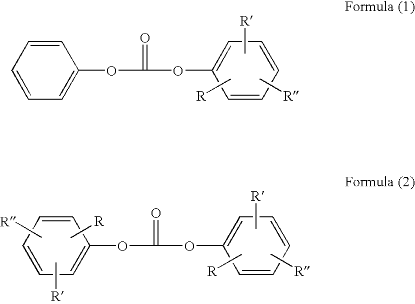

wherein R, R′ and R″ independently of one another can represent H, optionally branched C₁-C₃₄-alkyl/cycloalkyl, C₇-C₃₄-alkaryl or C₆-C₃₄-aryl, for example diphenyl carbonate, butylphenyl-phenyl carbonate, di-butylphenyl carbonate, isobutylphenyl-phenyl carbonate, di-isobutylphenyl carbonate, tert-butylphenyl-phenyl carbonate, di-tert-butylphenyl carbonate, n-pentylphenyl-phenyl carbonate, di-(n-pentylphenyl) carbonate, n-hexylphenyl-phenyl carbonate, di-(n-hexylphenyl) carbonate, cyclohexylphenyl-phenyl carbonate, di-cyclohexylphenyl carbonate, phenylphenol-phenyl carbonate, di-phenylphenol carbonate, isooctylphenyl-phenyl carbonate, di-isooctylphenyl carbonate, n-nonylphenyl-phenyl carbonate, di-(n-nonylphenyl) carbonate, cumylphenyl-phenyl carbonate, di-cumylphenyl carbonate, naphthylphenyl-phenyl carbonate, di-naphthylphenyl carbonate, di-tert-butylphenyl-phenyl carbonate, di-(di-tert-butylphenyl) carbonate, dicumylphenyl-phenyl carbonate, di-(dicumylphenyl) carbonate, 4-phenoxyphenyl-phenyl carbonate, di-(4-phenoxyphenyl) carbonate, 3-pentadecylphenyl-phenyl carbonate, di-(3-pentadecylphenyl) carbonate, tritylphenyl-phenyl carbonate, di-tritylphenyl carbonate, preferably diphenyl carbonate, tert-butylphenyl-phenyl carbonate, di-tert-butylphenyl carbonate, phenylphenol-phenyl carbonate, di-phenylphenol carbonate, cumylphenyl-phenyl carbonate, di-cumylphenyl carbonate, particularly preferably diphenyl carbonate. It is also possible to use mixtures of the mentioned carbonic acid diesters.

The amount of carbonic acid esters is from 100 to 130 mol %, preferably from 103 to 120 mol %, particularly preferably from 103 to 109 mol %, based on the dihydroxy compound.

In the melt transesterification process there are used as catalysts within the scope of the invention, as described in the mentioned literature, basic catalysts such as, for example, alkali and alkaline earth hydroxides and oxides, but also ammonium or phosphonium salts, which are referred to hereinafter as onium salts. Preference is given to the use of onium salts, particularly preferably phosphonium salts. Phosphonium salts within the scope of the invention are those of formula (3)

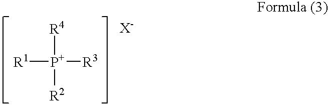

wherein R¹⁻⁴ can be the same or different C₁-C₁₀-alkyls, C₆-C₁₀-aryls, C₇-C₁₀-aralkyls or C₅-C₆-cycloalkyls, preferably methyl or C₆-C₁₄-aryls, particularly preferably methyl or phenyl, and X⁻ can be an anion, such as hydroxide, sulfate, hydrogen sulfate, hydrogen carbonate, carbonate, a halide, preferably chloride, or an alcoholate of the formula OR, wherein R can be C₆-C₁₄-aryl or C₇-C₁₂-aralkyl, preferably phenyl.

Preferred catalysts are tetraphenylphosphonium chloride, tetraphenylphosphonium hydroxide, tetraphenylphosphonium phenolate, particularly preferably tetraphenylphosphonium phenolate.

The catalysts are preferably used in amounts of from 10⁻⁸ to 10⁻³ mol, based on one mole of bisphenol, particularly preferably in amounts of from 10⁻⁷ to 10⁻⁴ mol.

Further catalysts can be used on their own or optionally in addition to the onium salt, in order to increase the rate of polymerization. Such further catalysts include salts of alkali metals and alkaline earth metals, such as hydroxides, alkoxides and aryl oxides of lithium, sodium and potassium, preferably hydroxide, alkoxide or aryl oxide salts of sodium. Sodium hydroxide and sodium phenolate are most preferred. The amounts of the cocatalyst can be in the range from 1 to 200 ppb, preferably from 5 to 150 ppb and most preferably from 10 to 125 ppb, in each case calculated as sodium.

The transesterification reaction of the aromatic dihydroxy compound and the carbonic acid diester in the melt is preferably carried oat in two stages. In the first stage, melting of the aromatic dihydroxy compound and of the carbonic acid diester takes place at temperatures of from 80 to 250° C., preferably from 100 to 230° C., particularly preferably from 120 to 190° C., under normal pressure, in from 0 to 5 hours, preferably from 0.25 to 3 hours. After addition of the catalyst, the oligocarbonate is prepared from the aromatic dihydroxy compound and the carbonic acid diester by applying a vacuum (up to 2 mm Hg) and raising the temperature (to up to 260° C.), by removal of the monophenol by distillation. The main amount of vapors from the process is thereby obtained. The oligocarbonate so prepared has a mean weight-average molar mass M, (determined by measuring the relative solution viscosity in dichloromethane or in mixtures of equal amounts by weight of phenol/o-dichlorobenzene, calibrated by light scattering) in the range from 2000 g/mol to 18,000 g/mol, preferably from 4000 g/mol to 15,000 g/mol.

In the second stage, the polycarbonate is prepared in the polycondensation by raising the temperature further to 250 to 320° C., preferably from 270 to 295° C., at a pressure of <2 mm Hg. The remainder of the vapors are thereby removed from the process.

It is also possible to use the catalysts in combination (two or more) with one another.

When alkali/alkaline earth metal catalysts are used, it can be advantageous to add the alkali/alkaline earth metal catalysts at a later time (e.g. after the oligocarbonate synthesis in the polycondensation in the second stage).

The reaction of the aromatic dihydroxy compound and the carbonic acid diester to give the polycarbonate can be carried out within the scope of the process according to the invention discontinuously or, preferably, continuously, for example in stirred vessels, thin-layer evaporators, falling-film evaporators, stirred vessel cascades, extruders, kneaders, simple tray reactors and high-viscosity tray reactors.

Analogously to the interfacial process, branched polycarbonates or copolycarbonates can be prepared by using polyfunctional compounds.

It is possible to mix with the polycarbonates according to the invention in known manner, for example by compounding, other aromatic polycarbonates and/or other plastics, such as aromatic polyesters, such as polybutylene terephthalate or polyethylene terephthalate, polyamides, polyimides, polyester amides, polyacrylates and polymethacrylates, such as, for example, polyalkyl (meth)acrylates and in particular polymethyl methacrylate, polyacetals, polyurethanes, polyolefins, halogen-containing polymers, polysulfones, polyether sulfones, polyether ketones, polysiloxanes, polybenzimidazoles, urea-formaldehyde resins, melamine-formaldehyde resins, phenol-formaldehyde resins, alkyd resins, epoxy resins, polystyrenes, copolymers of styrene or of alpha-methylstyrene with dienes or acrylic derivatives, graft polymers based on acrylonitrile/butadiene/styrene or graft copolymers based on acrylate rubber (see, for example, the graft polymers described in EP-A 640 655).

It is also possible to add to the polycarbonates according to the invention and the further plastics that are optionally present additives conventional for such thermoplastics, such as fillers, WV stabilizers, heat stabilizers, antistatics and pigments, in the conventional amounts; the mold-release behavior, the flow behavior and/or the flame resistance can optionally also be improved by the addition of external mold-release agents, flow improvers and/or flameproofing agents (e.g. alkyl and aryl phosphites, phosphates, phosphanes, low molecular weight carboxylic acid esters, halogen compounds, salts, chalk, quartz flour, glass fibers and carbon fibers, pigments and combinations thereof) Such compounds are described, for example, in WO 99/55772, p. 15-25, EP 1 308 084 and in the appropriate chapters of “Plastics Additives Handbook”, ed. Hans Zweifel, 5th Edition 2000, Hanser Publishers, Munich.

Polyols suitable for use in the compositions of the present invention include those having number-average molecular weights of from 250 to 20,000, preferably from 500 to 8000, particularly preferably from 500 to 6000, most particularly preferably from 1100 to 6000, and a functionality of from 1.5 to 8. For example, they are polyether polyols containing from two to four, preferably two, hydroxyl groups. Suitable commercial products are, for example, the polytetrahydrofuran homopolymers Tetrathane® 250 or Tetrathane® 2900 from DuPont. Suitable polyether polyols are also block copolymers and copolymers having an irregular sequence of the chain units, as well as mixtures of the polyether polyols.

Polyether polyols can be prepared by known processes, for example by anionic polymerisation of alkylene oxides in the presence of alkali hydroxides or alkali alcoholates as catalysts and with the addition of at least one starter molecule containing reactive hydrogen atoms, or by cationic polymerisation of alkylene oxides in the presence of Lewis acids such as antimony pentachloride or boron fluoride etherate, or by double metal cyanide (DMC) catalysis, Suitable alkylene oxides contain from 2 to 4 carbon atoms in the alkylene radical. Examples are tetrahydrofuran, 1,2-propylene oxide, 1,2- or 2,3-butylene oxide. The alkylene oxides can be used individually, alternately in succession or in the form of mixtures. There come into consideration as starter molecules water or di- and tri-hydric alcohols, such as ethylene glycol, 1,2-propanediol and 1,3-propanediol, diethylene glycol, dipropylene glycol, 1,4-ethanediol, glycerol, trimethylolpropane, etc.

Also suitable as polyether polyols are polymer-modified polyether polyols, preferably graft polyether polyols, in particular those based on styrene and/or acrylonitrile, which can be obtained by in situ polymerisation of acrylonitrile, styrene or, preferably, mixtures of styrene and acrylonitrile.

There can be used as further polyols the polyesters, polythioethers, polyacetals, polycarbonates and polyester amides containing at least two, preferably from 2 to 4, hydroxyl groups and generally having a number-average molecular weight of from 400 to 8000. The bifunctional polyether derivatives can be a homopolymer, a block copolymer or a copolymer having an irregular sequence of the chain units. Mixtures of the polyesters and polyethers can, of course, be used.

Within the scope of the present invention, the mentioned polyols can be used both on their own and in the form of mixtures of different polyols. The amount of polyol or polyols in the compositions according to the invention is from 0.01 wt. % to <0.3 wt. %, preferably from 0.01 wt. % to 0.25 wt. %, most particularly preferably from 0.01 wt. % to 0.12 wt. %, in particular from 0.03 to 0.11 wt. %, in each case based on the total composition.

In order to increase the flame resistance of compositions that are to be processed to transparent products, the use of polyols having four carbon atoms in the alkylene moiety is preferred. An example of such a preferred polyol is polytetrahydrofuran.

There are used as flameproofing agents alkali or alkaline earth salts of aliphatic or aromatic sulfonic acid, sulfonamide and sulfonimide derivatives.

Suitable salts include, for example: sodium or potassium perfluorobutanesulfate, sodium or potassium perfluoromethanesulfonate, sodium or potassium perfluorooctanesulfate, sodium or potassium 2,5-dichlorobenzenesulfate, sodium or potassium 2,4,5-trichlorobenzenesulfate, sodium or potassium methylphosphonate, sodium or potassium (2-phenyl-ethylene)-phosphonate, sodium or potassium pentachlorobenzoate, sodium or potassium 2,4,6-trichlorobenzoate, sodium or potassium 2,4-dichlorobenzoate, lithium phenylphosphonate, sodium or potassium diphenylsulfone-sulfonate, sodium or potassium 2-formylbenzenesulfonate, sodium or potassium (N-benzenesulfonyl)-benzenesulfonamide, trisodium or tripotassium hexafluoroaluminate, disodium or dipotassium hexafluorotitanate, disodium or dipotassium hexafluorosilicate, disodium or dipotassium hexafluorozirconate, sodium or potassium pyrophosphate, sodium or potassium metaphosphate, sodium or potassium tetrafluoroborate, sodium or potassium hexafluorophosphate, sodium or potassium or lithium phosphate, N-(p-tolylsulfonyl)-p-toluenesulfimide potassium salt, N—(N′-benzylaminocarbonyl)-sulfanylimide potassium salt.

Preference is given to sodium or potassium perfluorobutanesulfate, sodium or potassium perfluorooctanesulfate, sodium or potassium diphenylsulfone-sulfonate and sodium or potassium 2,4,6-trichlorobenzoate and N-(p-tolylsulfonyl)-p-toluenesulfimide potassium salt, N—(N′-benzylaminocarbonyl)-sulfanylimide potassium salt. Most particular preference is given to potassium nona-fluoro-1-butanesulfonate and sodium or potassium diphenyl-sulfonic acid sulfonate. Potassium nona-fluoro-1-butanesulfonate is available commercially inter alia as Bayowet®C4 (Lanxess, Leverkusen, Germany, CAS No. 29420-49-3), RM64 (Miteni, Italy) or 3M™ Perfluorobutanesulfonyl Fluoride FC-51 (3M, USA). Mixtures of the mentioned salts are also suitable.

Particular preference is given to potassium perfluorobutanesulfonate, potassium diphenyl-sulfonesulfonate, N-(p-tolylsulfonyl)-p-toluenesulfimide potassium salt, N—(N′-benzylaminocarbonyl)-sulfanylimide potassium salt, with potassium nona-fluoro-1-butanesulfonate being most particularly preferred.

These organic flameproofing salts are used in the molding compositions in amounts of from 0.01 wt. % to 0.8 wt. %, preferably from 0.02 wt. % to 0.6 wt. %, particularly preferably from 0.03 wt. % to 0.2 wt. %, most particularly preferably from 0.03 to 0.15 wt. %, in particular from 0.03 to 0.065 wt. %, in each case based on the total composition.

Suitable as further flameproofing agents are, for example, phosphorus-containing flameproofing agents selected from the groups of the monomeric and oligomeric phosphoric and phosphonic acid esters, phosphonate amines, phosphonates, phosphinates, phosphites, hypophosphites, phosphine oxides and phosphazenes, it also being possible to use as flameproofing agents mixtures of a plurality of components selected from one or various of these groups. It is also possible to use preferably halogen-free phosphorus compounds that are not mentioned specifically here, on their own or in any desired combination with other, preferably halogen-free phosphorus compounds. These also include purely inorganic phosphorus compounds such as boron phosphate hydrate. Phosphonate amines also come into consideration as phosphorus-containing flameproofing agents. The preparation of phosphonate amines is described, for example, in U.S. Pat. No. 5,844,028. Phosphazenes and their preparation are described, for example, in EP-A 728 811, DE-A 1 961 668 and WO 97/40092. Siloxanes, phosphorylated organosiloxanes, silicones or siloxysilanes can also be used as flameproofing agents, which is described in detail, for example, in EP 1 342 753, in DE 10257079 A1 and in EP 1 188 792.

Phosphorus-containing flameproofing additives within the scope of the invention are preferably selected from the groups of the monomeric and oligomeric phosphoric and phosphonic acid esters, phosphonate amines and phosphazenes, it also being possible to use as flameproofing additive mixtures of a plurality of components selected from one or various of these groups. It is also possible to use other halogen-free phosphorus compounds that are not mentioned specifically here, on their own or in any desired combination with other halogen-free phosphorus compounds.

Preferred monomeric and oligomeric phosphoric and phosphonic acid esters are phosphorus compounds of the general formula (4)

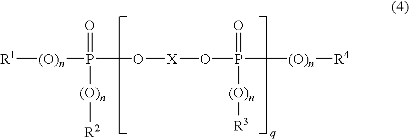

wherein R¹, R², R³ and R⁴ independently of one another represent in each case optionally halogenated C₁- to C₈-alkyl, or C₅- to C₆-cycloalkyl, C₆- to C₂₀-aryl or C₇- to C₁₂-aralkyl each optionally substituted by alkyl, preferably C₁- to C₄-alkyl, and/or by halogen, preferably chlorine or bromine, each of the substituents n independently of the others represents 0 or 1, q represents from 0 to 30 and X represents a mono- or poly-nuclear aromatic radical having from 6 to 30 carbon atoms, or a linear or branched aliphatic radical having from 2 to 30 carbon atoms which can be OH-substituted and can contain up to 8 ether bonds.

R¹, R², R³ and R⁴ independently of one another preferably represent C₁- to C₄-alkyl, phenyl, naphthyl or phenyl-C₁-C₄-alkyl. The aromatic groups R¹, R², R³ and R⁴ can in turn be substituted by halogen and/or alkyl groups, preferably chlorine, bromine and/or C₁- to C₄-alkyl. Particularly preferred aryl radicals are cresyl, phenyl, xylenyl, propylphenyl or butylphenyl as well as the corresponding brominated and chlorinated derivatives thereof.

X in formula (4) preferably represents a mono- or poly-nuclear aromatic radical having from 6 to 30 carbon atoms. It is preferably derived from bisphenols of formula (1).

Each of the substituents n in formula (4), independently of the others, can be 0 or 1; n is preferably 1, and q represents values from 0 to 30, preferably from 0.3 to 20, particularly preferably from 0.5 to 10, especially from 0.5 to 6, most particularly preferably from 1.1 to 1.6.

X particularly preferably represents

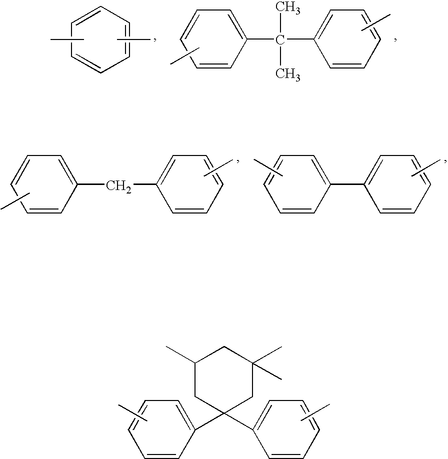

or chlorinated or brominated derivatives thereof; in particular X is derived from resorcinol, hydroquinone, bisphenol A or diphenylphenol. X is particularly preferably derived from bisphenol A.

It is also possible to use mixtures of different phosphates according to formula (4) as phosphorus-containing flameproofing agents.

Phosphorus compounds of formula (4) are in particular tributyl phosphate, triphenyl phosphate, tricresyl phosphate, diphenylcresyl phosphate, diphenyloctyl phosphate, diphenyl-2-ethylcresyl phosphate, tri-(isopropylphenyl) phosphate, resorcinol-bridged oligophosphate and bisphenol A-bridged oligophosphate. The use of oligomeric phosphoric acid esters of formula (4) that are derived from bisphenol A is particularly preferred.

The most preferred phosphorus-containing flameproofing additive is bisphenol A-based oligophosphate according to formula (IVa)

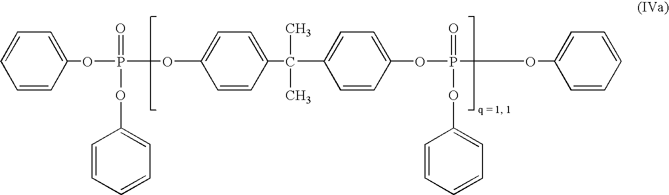

The phosphorus compounds are known (see e.g. EP-A 0 363 608, EP-A 0 640 655) or can be prepared according to known methods in an analogous manner (e.g. Ullmanns Enzylklopädie der technischen Chemie, Vol. 18, p. 301 ff 1979; Houben-Weyl, Methoden der organischen Chemie, Vol. 12/1, p. 43; Beilstein Vol. 6, p. 177).

If mixtures of different phosphorus compounds are used, and in the case of oligomeric phosphorus compounds, the indicated q value is the mean q value. The mean q value can be determined by determining the composition of the phosphorus compound (molecular weight distribution) by means of a suitable method (gas chromatography (GC), high pressure liquid chromatography (HPLC), gel permeation chromatography (GPC)) and calculating the mean values for q therefrom.

It is also possible to use phosphonate amines and phosphazenes, as are described in WO 00/00541 and WO 01/18105, as flameproofing additives.

The flameproofing additives can be used on their own or in any desired mixture with one another or in admixture with other flameproofing additives.

Phosphorus-containing flameproofing additives are available commercially, for example Reofos® BAPP (Chemtura, Indianapolis, USA), NcendX® (Albemarle, Baton Rouge, La., USA), Fyrolflex® BDP (Akzo Nobel, Arnheim, Netherlands), CR 741® (Daihachi, Osaka, Japan), Reofos® TPP (Chemtura), Fyrolfilex® TPP (Akzo Nobel), Disfiamoll® TP (Lanxess), Reofos RDP (Chemtura) or Fyrolflex® RDP (Akzo Nobel).

If required, phosphorus-containing flameproofing additives are added in amounts of preferably up to 30 wt. %, particularly preferably from 2 to 25 wt. %, most particularly preferably from 3 to 15 wt. % (based on the total composition).

Antidripping agents can also be added to the compositions. Polytetrafluoroethylene (PTFE), for example, is mentioned as an antidripping agent. PTFE is available commercially in various product grades. These include additives such as Hostaflon® TF2021 or PTFE blends such as Metablen® A-3800 (about 40% PTFE CAS 9002-84-0 and about 60% methyl methacrylate/butyl acrylate copolymer CAS 25852-37-3 from Mitsubishi-Rayon) or Blendex® B449 (about 50% PTFE and about 50% SAN [80% styrene and 20% acrylonitrile] from Chemtura).

Within the scope of the present invention, PTFE is used in amounts of from 0.05 wt. % to 5 wt. %, preferably from 0.1 wt. % to 1.0 wt. %, particularly preferably from 0.1 wt. % to 0.5 wt. %, in each case based on the total composition.

Further suitable flameproofing agents within the scope of the present invention are halogen-containing compounds. These include brominated compounds such as brominated oligocarbonates (e.g. tetrabromobisphenol A oligocarbonate BC-52®, BC-58®, BC-52HP® from Chemtura), polypentabromobenzyl acrylates (e.g. FR 1025 from Dead Sea Bromine (DSB)), oligomeric reaction products of tetrabromo-bisphenol A with epoxides (e.g. FR 2300 and 2400 from DSB) or brominated oligo- or poly-styrenes (e.g. Pyro-Chek® 68PB from Ferro Corporation, PDBS 80 and Firemaster® PBS-64HW from Chemtura).

Particular preference is given within the scope of this invention to brominated oligocarbonates based on bisphenol A, in particular tetrabromobisphenol A oligocarbonate.

Within the scope of the present invention, bromine-containing compounds are used in amounts of from 0.1 wt. % to 30 wt. %, preferably from 0.1 wt. % to 20 wt. %, particularly preferably from 0.1 wt. % to 10 wt. % and most particularly preferably from 0.1 wt. % to 5.0 wt. %, in each case based on the total composition.

Chlorine-containing flameproofing agents such as, for example, tetrachlorophthalimides can further be used.

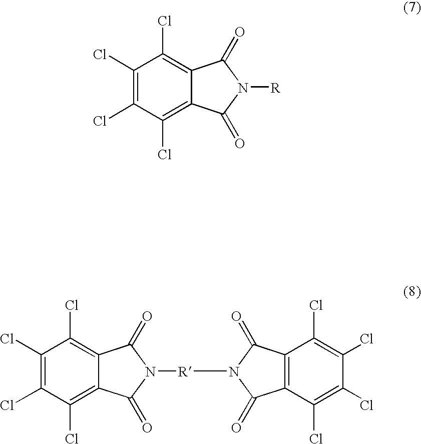

The following may be mentioned as examples of suitable tetrachlorophthalimides according to formula (7) within the scope of the invention: N-methyl-tetrachlorophthalimide, N-ethyl-tetrachlorophthalimide, N-propyl-tetrachloro-phthalimide, n-isopropyl-tetrachlorophthalimide, N-butyl-tetrachlorophthalimide, N-isobutyl-tetrachlorophthalimide, N-phenyl-tetrachlorophthalimide, N-(4-chlorophenyl)-tetrachlorophthalimide, N-(3,5-dichlorophenyl)-tetrachlorophthalimide, N-(2,4,6-trichlorophenyl)-tetrachlorophthalimide, N-naphthyl-tetrachlorophthalimide. The following may be mentioned as examples of suitable tetrachlorophthalimides according to formula (8) within the scope of the invention: N,N′-ethylene-di-tetrachlorophthalimide, N,N′-propylene-di-tetrachlorophthalimide, N,N′-butylene-di-tetrachlorophthalimide, N,N′-p-phenylene-di-tetrachlorophthalimide, 4,4′-di-tetrachlorophthalimido-diphenyl, N-(tetrachlorophthalimido)-tetrachlorophthalimide.

Particularly suitable within the scope of the invention are N-methyl- and N-phenyl-tetrachlorophthalimide, N,N′-ethylene-di-tetrachlorophthalimide and N-(tetrachlorophthalimido)-tetrachlorophthalimide.

Mixtures of different tetrachlorophthalimides of formulae (7) or (8) can likewise be used.

Within the scope of the present invention, the mentioned chlorine-containing compounds are used in amounts of from 0.1 wt. % to 30 wt. %, preferably from 0.1 wt. % to 20 wt. %, particularly preferably from 0.1 wt. % to 10 wt. % and most particularly preferably from 0.1 wt. % to 5.0 wt. %, in each case based on the total composition.

The bromine- and chlorine-containing flameproofing agents can also be used in combination with antimony trioxide.

The present invention is not limited to the mentioned flameproofing agents; rather, further flame-inhibiting additives as described, for example, in J. Troitzsch, “International Plastics Flammability Handbook”, Hanser Verlag, Munich 1990 can also be used.

When choosing further flameproofing agents it must be ensured that the transparency is not adversely affected.

It is also possible to add to the polycarbonates and copolycarbonates according to the invention additives conventional for these thermoplastics, such as fillers, UV stabilizers, heat stabilizers, mold-release agents, flow improvers, antistatics and pigments, in the conventional amounts. Heat stabilizers, such as, for example and preferably, tris-(2,4-di-tert-butylphenyl) phosphate or triphenylphosphine, are preferably added in an amount of from 10 to 3000 ppm, based on the total composition.

### Preparation of the Compositions:

The preparation of a composition comprising polycarbonate, at least one polyol and at least one flameproofing additive is carried out using conventional methods of incorporation and can be effected, for example, by mixing solutions of the flameproofing additive and of the polyol with a solution of polycarbonate in suitable solvents such as dichloromethane, haloalkanes, haloaromatic compounds, chlorobenzene and xylenes. The substance mixtures are then preferably homogenized in known manner by extrusion. The solution mixtures are preferably worked up, for example compounded, in known manner by evaporation of the solvent and subsequent extrusion.

Moreover, the composition can be mixed in conventional mixing devices, such as screw extruders (for example twin-screw extruders, ZSK), kneaders, Brabender or Banbury mills, and then extruded. After extrusion, the extrudate can be cooled and comminuted. It is also possible for individual components to be pre-mixed and the remaining starting materials then to be added individually and/or likewise in the form of a mixture.

The compositions according to the invention can be worked up in known manner and processed to molded bodies of any kind, for example by extrusion, injection molding or extrusion blow-molding.

Coextruded solid polycarbonate sheets can be produced, for example, by means of the following machines and apparatuses:
the main extruder with a screw of length 33 D and a diameter of 70 mm, with degassing,
a coextruder for applying the top layer, with a screw of length 25 D and a diameter of 35 mm,
a special coextrusion sheet die having a width of 450 mm,
a smoothing calender,
a roller conveyor,
a take-off device,
a device for cutting to length (saw),
a delivery table.

Coextruded multi-wall polycarbonate sheets can be produced, for example, by means of the following machines and apparatuses:
the main extruder with a screw of length 33 D and a diameter of 70 mm, with degassing,
the coex adapter,
a coextruder for applying the top layer, with a screw of length 25 D and a diameter of 30 mm,
the special sheet die having a width of 350 mm,
the calibrator,
the roller conveyor,
the take-off device,
the device for cutting to length (saw),
the delivery table.

In the case of both types of sheet, the polycarbonate granules forming the base material are fed to the feeding funnel of the main extruder, and the coextrusion material is fed to the feeding funnel of the coextruder. Melting and feeding of the material in question takes place in the respective cylinder/screw plasticizing system. The two material melts are combined in the coex adapter and, after leaving the die and cooling, form a composite. The further devices serve to transport the extruded sheets, cut them to length and deposit them.

Sheets without a coextruded layer are produced in a corresponding manner, either by not operating the coextruder or by filling it with the same polymer composition as the main extruder.

The blow molding of polycarbonate is described in detail inter alia in DE-A 102 29 594 and literature cited therein.

The invention will now be described in further detail with reference to the following non-limiting examples.

### EXAMPLES

### Flameproofing Test

The behavior in fire was determined according to method UL94V Underwriters Laboratories Inc. Standard of Safety, “Test for Flammability of Plastic Materials for Parts in Devices and Appliances”, p. 14 ff, Northbrook 1998; b) J. Troitzsch, “International Plastics Flammability Handbook”, p. 346 ft Hanser Verlag, Munich 1990). For a flameproof plastic to be rated in fire classification UL94V-0, the following specific criteria must be met: in a set of 5 ASTM standard test specimens (dimensions. 127×12.7×X, where X=thickness of the test specimen, e.g. 3.2; 3.0; 1.5, 1.0 or 0.75 mm), none of the samples must exhibit afterburning for longer than 10 seconds after twice being exposed for 10 seconds to a naked flame of a specified height. The sum of the afterburning times on application of flame 10 times to 5 samples must not be greater than 50 seconds. In addition, there must be no flaming drops, complete consumption or afterglow of the test specimen for longer than 30 seconds. The UL94V-1 rating requires the individual afterburning times to be less than 30 seconds and the sum of the afterburning times from 10 flame applications to 5 samples to be less than 250 seconds, The total afterglow time must not be more than 250 seconds, The remaining criteria are identical with those mentioned above. A rating of fire classification UL94V-2 is made when there are flaming drops but the remaining criteria of UL94V-1 are met.

The flameproofing test was carried out on test rods of dimensions 127×12.7×X mm, where X is the thickness of the test specimen, which is given in the table.

The haze and transmission were determined in accordance with DIN 5036 on sheets 60×40×4 mm in size.

### Preparation of the Examples

The compounding device consists of:

Metering Device for the Components
a co-rotating twin-screw kneader (ZSK 53 from Werner & Pfleiderer) with a screw diameter of 53 mm
a perforated die for forming molten threads
a water bath for cooling and solidifying the threads
a granulator.
   KFBS and the appropriate polyols are mixed in powder form with the polycarbonate powder and compounded into the polycarbonate. By means of the above-described compounding device, the compositions indicated in Table 1 are prepared.

TABLE 1
(amounts in wt. %)

| | Example | | | | | | | |
|---|---|---|---|---|---|---|---|---|
| | 1V | 2 | 3 | 4V | 5 | 6 | 7 | 8V |
| Polycarbonate | to 100 | to 100 | to 100 | to 100 | to 100 | to 100 | to 100 | to 100 |
| granules | wt. % | wt. % | wt. % | wt. % | wt. % | wt. % | wt. % | wt. % |
| Polycarbonate | 6.935 wt. % | 6.885 wt. % | 6.835 wt. % | 6.9 | 6.8 | 6.4 | 6.8 | 6.4 |
| powder | | | | | | | | |
| KFBS | 0.065 | 0.065 | 0.065 | 0.1 | 0.1 | 0.1 | 0.1 | 0.1 |
| PTHF | — | 0.05 | 0.1 | — | 0.1 | 0.5 | — | — |
| PEG | — | — | — | — | — | — | 0.1 | 0.5 |
| UL 94 at 2.6 mm | V2 | V0 | V0 | — | — | — | — | — |
| UL 94 at 2.8 mm | V2 | V0 | V0 | — | — | — | — | — |
| UL 94 at 3.0 mm | V1 | V0 | V0 | V0 | V0 | V0 | V0 | V0 |
| UL 94 at 3.2 mm | V1 | V0 | V0 | V0 | V0 | V0 | V0 | V0 |
| Haze | 0.4 | 0.2 | 0.2 | 1.4 | 0.7 | 2.6 | 1.3 | 2.6 |
| Transmission | 88.96 | 89.15 | 89.18 | 87.6 | 88.58 | 87.66 | 86.3 | 83.12 |

Polycarbonate (granules): polycarbonate (based on bisphenol A) having a mean molecular weight M_{w} of 28,000 (Makrolon ® 2808 from Bayer MaterialScience AG)
Polycarbonate (powder): polycarbonate (based on bisphenol A) having a mean molecular weight M_{w} of 31,000 (Makrolon ® 3108 from Bayer MaterialScience AG)
PTHF: polytetrahydrofuran having a mean molecular weight of 2900 (Tetrathane ® 2900 from DuPont)
PEG: polyethylene glycol having a mean molecular weight of 8000
PPG: polypropylene glycol having a mean molecular weight of 500
KFBS: potassium nona-fluoro-1-butanesulfonate
V in Table 1 stands for Comparison

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A composition comprising: a polycarbonate; 0.01 to <0.3 wt. % of a polyol; and 0.01 to 0.8 wt. % of a salt of a metal selected from the group consisting of alkali metals, alkaline earth metals and mixtures thereof, and a compound selected from the group consisting of sulfonic acids, sulfonamides, sulfonimides and mixtures thereof.

2. The composition according to claim 1, wherein the polyol is present in an amount of 0.01 to 0.25 wt. %.

3. The composition according to claim 1, wherein the polyol is present in an amount of 0.01 to 0.12 wt. %.

4. The composition according to claim 1, wherein the polyol is present in an amount of 0.03 to 0.11 wt. %; and wherein the salt is present in an amount of 0.03 to 0.15 wt. %.

5. The composition according to claim 1, wherein the polyol is present in an amount of 0.03 to 0.11 wt. %; and wherein the salt is present in an amount of 0.03 to 0.065 wt. %.

6. The composition according to claim 1, wherein the polyol has a molecular weight of 250 to 20,000.

7. The composition according to claim 1, wherein the polyol has a molecular weight of 1100 to 6000.

8. The composition according to claim 1, wherein the compound selected from the group consisting of sulfonic acids, sulfonamides, sulfonimides and mixtures thereof is aliphatic.

9. The composition according to claim 1, wherein the salt comprises one or more selected from the group consisting of a nona-fluoro-1-butanesulfonate, a diphenyl-sulfonic acid sulfonate and mixtures thereof, of an alkali metal selected from the group consisting of sodium, potassium and mixtures thereof.

10. The composition according to claim 1, wherein the salt comprises sodium or potassium nona-fluoro-1-butanesulfonate.

11. The composition according to claim 1, wherein the polyol comprises a polyether polyol.

12. The composition according to claim 1, wherein the polyether polyol comprises a poly-C₂₋₄-alkylene polyol.

13. The composition according to claim 1, wherein the polyol comprises polytetrahydrofuran.

14. The composition according to claim 1, further comprising all antidripping agent.

15. The composition according to claim 14, wherein the antidripping agent comprises a polytetrafluoroethylene.

16. A product comprising a composition according to claim 1.

17. An injection-molded, flame-resistant product comprising a composition according to claim 1.
